(19) United States
(12) Patent Application Publication
(10) Pub. No.: US 2022/0022640 A1
(43) Pub. Date: Jan. 27, 2022

(54) Paint Brush with Integrated Cleaning Mechanism

(71) Applicant: Zane Sundquist, Stuart, FL (US)

(72) Inventor: Zane Sundquist, Stuart, FL (US)

(21) Appl. No.: 17/379,143

(22) Filed: Jul. 19, 2021

Related U.S. Application Data
(60) Provisional application No. 63/054,323, filed on Jul. 21, 2020.

(51) Int. Cl. A46B 17/06; B44D 3/00; A46B 11/06

(52) U.S. Cl. CPC A46B 17/06; A46B 2200/202; A46B 11/06; B44D 3/006

(57) ABSTRACT

The present invention relates generally to the field of paint brushes. More specifically, the present invention relates to an improved paint brush that is comprised of a hollow body and hollow stem. The stem of the brush can further receive a hose, wherein the hose can allow water to flow through the stem and body, and out of the top surface of the body via a plurality of continuous openings. The top surface also receives a brush head assembly that is comprised of a hollow base and a plurality of bristles. The brush head assembly is further removably secured to the top surface via a sidewall and a locking member that can be engaged or disengaged from a locked position to allow the assembly to be removed from the body for cleaning or replacement.

### CROSS-REFERENCE TO RELATED APPLICATION

The present application claims priority to, and the benefit of, U.S. Provisional Application No. 63/054,323, which was filed on Jul. 21, 2020 and is incorporated herein by reference in its entirety.

### FIELD OF THE INVENTION

The present invention relates generally to the field of paint brushes. More specifically, the present invention relates to an improved paint brush that is comprised of a hollow body and a stem. The stem of the brush can further receive a hose, wherein the hose can allow water to flow through the stem and body and out of the top surface of the body via a plurality of continuous openings. The top surface also receives a brush head assembly that is comprised of a hollow base and a plurality of bristles. The brush head assembly is further removably secured to the top surface via a sidewall and a locking member that can be engaged or disengaged from a locked position to allow the assembly to be removed from the body for cleaning or replacement.

Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

Many individuals paint as a hobby, while touching up areas of their home, or paint commercially or residentially as a professional. Accordingly, paint brushes must be cleaned after each use. If not properly cleaned, dried paint can accumulate on the bristles of a paint brush. This dried paint must then be removed from the bristles which is a tedious, physically involved and time-consuming process, especially when the paint has been dry for a long period of time. Further, if dried paint remains on the bristles of a paintbrush long enough, the paint cannot be removed in an efficient and timely manner, and the entire paintbrush must be discarded, which is obviously economically undesirable for all users.

In addition, painting may involve a plurality of paint of different colors. However, if a user only possesses one or a limited amount of paint brushes, each brush must be cleaned before the brush is used for a different paint color. Depending on the amount of brushes and the number of paints being used, this repeated cleaning process can also be incredibly time-consuming, burdensome and undesirable. However, a user can only combat this problem by purchasing more paint brushes, which may not be economically viable for the user.

Therefore, there exists a long-felt need in the art for an improved paint brush. More specifically, there exists in the art a long-felt need for a paint brush with an integrated cleaning mechanism that allows for the brush to be quickly and easily cleaned after each use. Further, there exists a long-felt need in the art for an improved paint brush that allows a user to quickly clean the bristles of the brush in order to paint with a plurality of different colors in quick succession. Finally, there is a long-felt need in the art for a paint brush with an integrated cleaning mechanism that is relatively inexpensive to manufacture, and both safe and easy to use.

The subject matter disclosed and claimed herein, in one embodiment thereof, comprises an improved paint brush, wherein the brush is comprised of an interchangeable and detachable brush head. Further, the brush is comprised of a hollow handle that can receive a hose connection. After being connected to the handle, a hose can be used to apply water through the handle, wherein the water exits the handle via a plurality of continuous openings and flows into the brush head. Therefore, the brush head can be easily cleaned, but also easily replaced as necessary.

In this manner, the improved paint brush of the present invention accomplishes all of the forgoing objectives and provides a paint brush that can be easily cleaned. Further, the improved paint brush is more versatile than existing paint brushes known in the art due to the fact that it can accept differing replaceable brush heads. Therefore, the brush of the present invention allows a user to easily clean paint brushes in an improved manner.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an improved paint brush. The device is comprised of a paintbrush that is further comprised of a hollow stem and hollow body. The bottom of the stem is further comprised of a plurality of male threads that can receive the female threads of a hose and can be covered by a threaded cap when not in use. The top surface of the body is comprised of a generally T-shaped member, wherein the top surface of the member is comprised of a plurality of continuous openings that allow water to flow out of the top surface.

The device also contains a brush head assembly that is comprised of a plurality of bristles that are attached to a base. The base of the device can further be secured to the top surface of the body around the T-shaped member via a locking member and a sidewall. In this regard, the base is pinned between the sidewall and a lip of the locking member. Further, the top surface of the locking member may be comprised of a plurality of protrusions that can engage a plurality of grooves within the side surfaces of the base, to thereby further secure the brush head assembly to the top surface of the body.

As a result, a user can easily attach or detach a brush head assembly from the body. Further, the device may be comprised of a brush head kit that is comprised of a plurality of brush heads of differing bristle types. In addition, the design of the brush head assembly, body and locking member allow a user to easily discard the brush head as desired, without needing to discard the entire device.

Therefore, the improved paint brush device of the present invention is particularly advantageous as it provides a thorough and easy means of cleaning a paint brush via a hose. Further, the device allows a user to easily switch brush heads as desired, which may be especially advantageous when painting with multiple colors at one time, and where each color requires a different brush head to be used. In addition, in the event that a brush head does need to be discarded, a user can discard the brush head without having to discard the entire device.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an improved paint brush device of the present invention in accordance with the disclosed architecture;

FIG. 2A illustrates a perspective view of the stem of one potential embodiment of an improved paint brush device of the present invention in accordance with the disclosed architecture;

FIG. 2B illustrates an enhanced perspective view of one potential embodiment of an improved paint brush device of the present invention while attached to a hose in accordance with the disclosed architecture;

FIG. 2C illustrates a perspective view of one potential embodiment of an improved paint brush device of the present invention while attached to a hose in accordance with the disclosed architecture;

FIG. 3 illustrates a perspective view of one potential embodiment of an improved paint brush device of the present invention in accordance with the disclosed architecture; and

FIG. 4 illustrates a side view of one potential embodiment of an improved paint brush device of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved paint brush. Further, there exists in the art a long-felt need for an improved paint brush that can be easily cleaned. Finally, there exists a long-felt need in the art for an improved paint brush that allows a user to quickly clean the bristles of the brush in order to paint with a plurality of colors at one time.

The present invention, in one exemplary embodiment, comprises an improved paint brush. The device is comprised of a paint brush that is further comprised of a hollow stem and hollow body, wherein the bottom of the stem is further comprised of a plurality of male threads that can receive the female threads of a hose. Further, the threads may also be covered by a threaded cap when not in use. The top surface of the body is also comprised of a generally T-shaped member, wherein the top surface of the member is comprised of a plurality of continuous openings that allow water to flow out of the top surface.

The device also contains a brush head assembly that is comprised of a plurality of bristles that are attached to a base, wherein the base of the device can further be secured to the top surface of the body around the T-shaped member via a locking member and a sidewall. Therefore, the base is pinned between the sidewall and a lip of the locking member. Further, the top surface of the locking member may be comprised of a plurality of protrusions that can engage a plurality of grooves within the side surfaces of the base, to further secure the brush head assembly to the top surface of the body. Accordingly, a user can easily attach or detach a brush head assembly from the body. Further, the device may be comprised of a brush head kit that is comprised of a plurality of brush heads of differing bristle types. In addition, the design of the brush head assembly, body and locking member allow a user to easily discard the brush head as desired, without needing to discard the entire device.

As such, the improved paint brush device of the present invention is particularly advantageous as it provides a thorough and easy means of cleaning a paint brush via a hose. Further, the device allows a user to easily switch brush heads as desired, which may be especially advantageous when painting with multiple colors at one time, and wherein each color requires a different brush head to be used. In addition, in the event that a brush head does need to be discarded, a user can discard the brush head without having to discard the entire device.

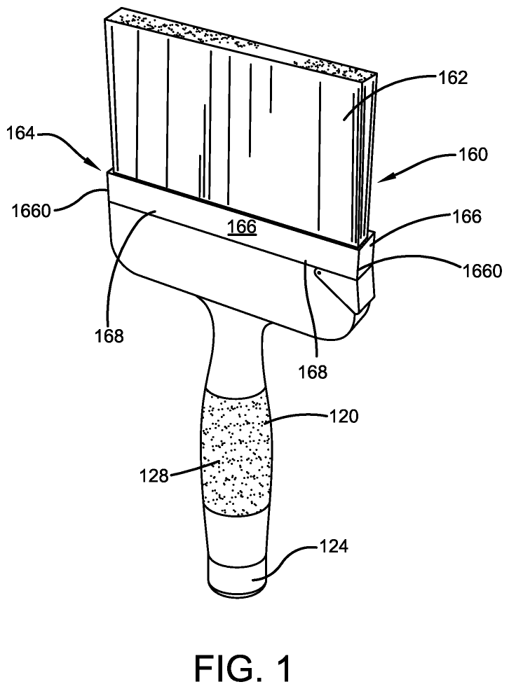

Referring initially to the drawings, FIG. 1 illustrates a perspective view of one potential embodiment of an improved paint brush device 100 of the present invention in accordance with the disclosed architecture. The device 100 is preferably comprised of a body 110 that has a hollow stem 120, a top surface 130, a side surface 140 and a brush head assembly 160. The body 110 is preferably comprised of a rigid plastic such as but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. In addition, the body 110 may be comprised of aluminum or stainless steel.

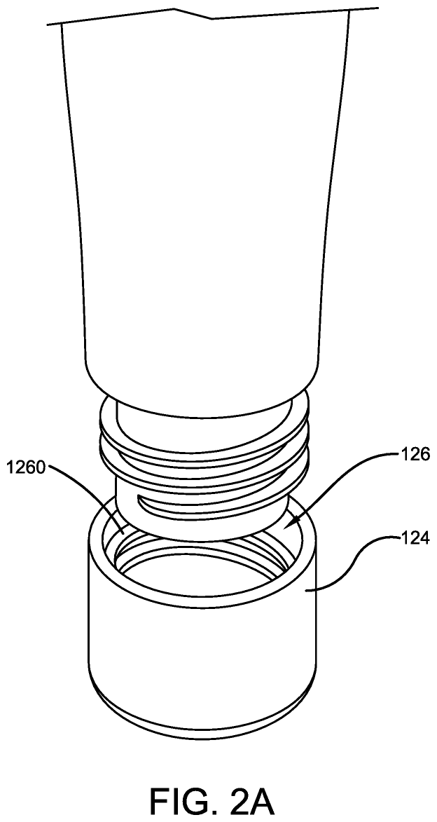

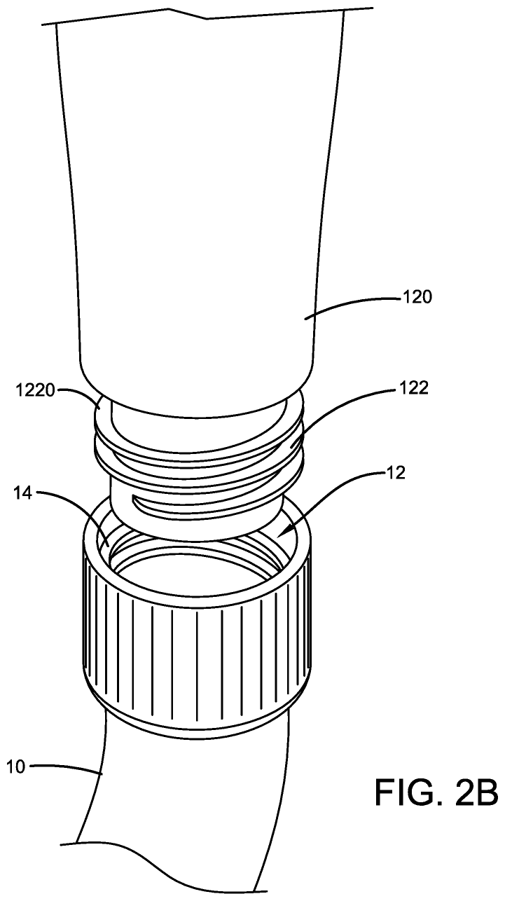

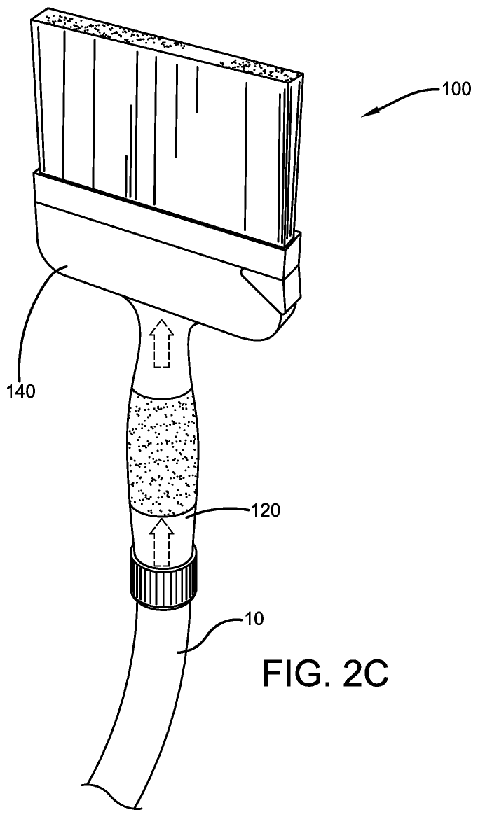

FIG. 2A illustrates a perspective view of the stem 120 of one potential embodiment of an improved paint brush device 100 of the present invention in accordance with the disclosed architecture. The stem 120 is preferably cylindrical in shape and may be comprised of a textured grip surface 128 to allow a user to easily grasp the device 100. The bottom of the stem 120 contains a male threaded member 122 that further contains male threads 1220. Said threads 1220 may be covered by a removable cap 124, wherein the interior surface of the cap 124 contains female threads 1260. However, a hose 10 (shown as prior art) that contains female threads 14 on its interior surface 12 may be attached to the male threaded member 122 of the stem 120, as shown in FIG. 2C.

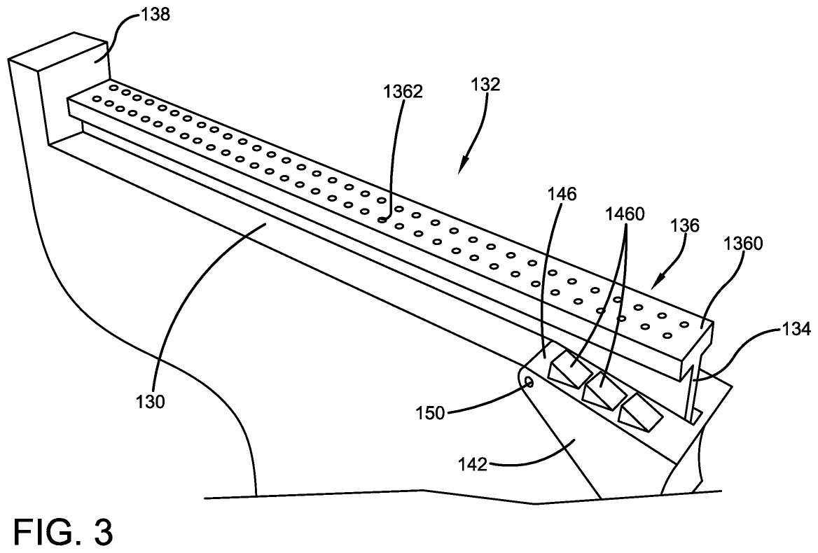

FIG. 3 illustrates a perspective view of one potential embodiment of an improved paint brush device 100 of the present invention in accordance with the disclosed architecture. The top surface 130 of the body 100 is further comprised of a generally T-shaped member 132 that is made of the same material as the body 110. The member 132 contains a vertical member 134 and perpendicular horizontal member 136, wherein the top surface 1360 of the horizontal member 136 is comprised of a plurality of continuous openings 1362. The device 100 is also comprised of a brush head assembly 160 which is made of a base 164 that the top surface 1360 receives. The base 164 is comprised of two sets of parallel side surfaces 166, wherein the bottom edges 168 of said surfaces 166 contact the top surface 130 of the body 110 around the T-shaped member 132.

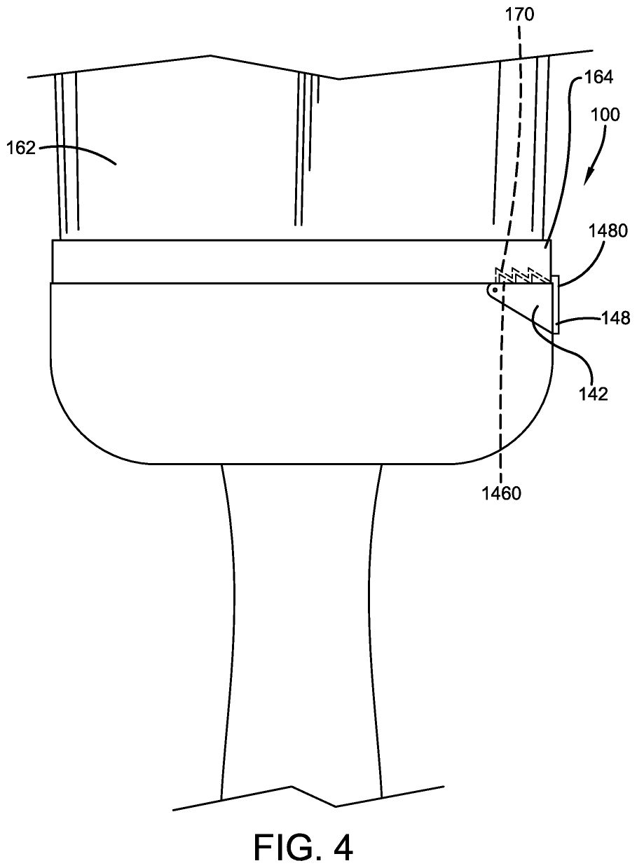

The base 164 of the brush head assembly 160 is further secured to the top surface 130 of the body 110 via a locking member 142 that attaches to the side surface 140 of the body 110 via a hinge 150. In a locked position, the member 142 is positioned such that vertical edge 1480 of the exterior lip 148 is parallel to the vertical edges 1660 of the side surfaces 166 of the base 164. Therefore, the base 164 is secured around the T-shaped member 132, wherein the bottom surfaces 168 of the base 164 contact the top surface 130 of the body 110 and are pinned between the lip 148 and sidewall 138, such that the assembly 160 is secured to the body 110. Further, the top surface 146 of the locking member 142 is comprised of a plurality of locking protrusions 1460 which are angled and received by locking protrusion grooves 170 within the side surfaces 166 of the base 164, as seen in FIG. 4. Therefore, the brush head assembly 160 can be securely attached to the body 110 and removed as needed. Further, the device 100 may be comprised of a kit of brush heads 160 with a plurality of bristle 162 shapes, fine-nesses, and artificial/natural material compositions. The locking member 142 can further be placed in an unlocked position to allow the brush head assembly 160 to be removed from the body 110, by pushing the member 142 downwards (about the hinge 150) towards the stem 120.

Accordingly, in order to clean a brush head assembly 160 while attached to the body 110, a user inserts and tightens a hose 10 into the male-threaded member 122 as noted and best seen in FIG. 2B. Then, water can be pumped through the hollow stem 120 and hollow body 110, through the continuous openings 1362 which are then located within the base 162 (e.g. when the assembly 160 is attached to the body 110), and then clean the base 164 and bristles 162. As such, this method of internal cleaning more thoroughly cleans the bristles 162 and the body 110 better than conventional means. Further, in the event that a user forgets to clean the brush head assembly 160, as user can easily replaced the brush head 160 by disengaging the locking member 142 by the member 142 downwards towards the stem 120, and replacing the old assembly 160 with a new assembly 160.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “improved paint brush”, “improved paint brush device”, and “device”, are interchangeable and refer to the improved paint brush device 100 of the present invention.

Notwithstanding the forgoing, the improved paint brush device 100 of the present invention and its various components can be of any suitable size and configuration as is known in the art without affecting the overall concept of the invention, provided that they accomplish the above-stated objectives. One of ordinary skill in the art will appreciate that the size, configuration and material of the improved paint brush device 100 as shown in the FIGS. are for illustrative purposes only, and that many other sizes and shapes of the improved paint brush device 100 are well within the scope of the present disclosure. Although the dimensions of the improved paint brush device 100 are important design parameters for user convenience, the improved paint brush device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A paint brush comprising:
a stem, wherein the stem has a continuous opening therein;
a hollow body; and
a brush head assembly.

2. The paint brush of claim 1, wherein the brush head assembly is removably attached to the hollow body.

3. The paint brush of claim 2, wherein the hollow body is in fluid communication with the continuous opening.

4. The paint brush of claim 3, wherein the top surface of the body is comprised of a plurality of continuous openings that are in fluid communication with the hollow body.

5. A paint brush comprising:
a stem;
a body further comprising a continuous passageway and a top surface that is comprised of a T-shaped member;
a locking member; and
a brush head assembly having a base.

6. The paint brush of claim 5, wherein the T-shaped member is comprised of a plurality of continuous openings that are in fluid communication with the continuous passageway.

7. The paint brush of claim 6, wherein the base of the brush head assembly is secured around the T-shaped member via the locking member.

8. The paint brush of claim 7, wherein the locking member attaches to a side surface of the body via a hinge.

9. A paint brush comprising:
a hollow stem;
a threaded cap that can be secured to the hollow stem;
a body comprising a continuous opening therein, a top surface, a T-shaped member positioned at the top surface and a sidewall;
a movable locking member that is comprised of a lip and attaches to the body via a hinge; and
a brush head assembly comprised of a base.

10. The paint brush of claim 9, wherein a bottom of the hollow stem is comprised of a male thread that can receive a hose.

11. The paint brush of claim 10, wherein the brush head assembly is comprised of a plurality of bristles.

12. The paint brush of claim 11, wherein the brush head assembly is secured to the top surface of the body via the sidewall and the lip of the locking member.

13. The paint brush of claim 12, wherein the lip of the locking member is substantially parallel to a vertical edge of a side surface of the base.

14. The paint brush of claim 13, wherein a top surface of the movable locking member is comprised of a plurality of protrusions.

15. The paint brush of claim 14 further comprising a plurality of protrusion grooves within the side surface of the base that receive the protrusions of the locking member.

16. The paint brush of claim 15, wherein a hose can be attached to the hollow stem so that a flow of water can pass through the hollow stem, the continuous opening of the body, and out a plurality of continuous openings in the T-shaped member in order to clean the plurality of bristles.

17. The paint brush of claim 16, wherein the stem and the T-shaped member are comprised of a plastic.

18. The paint brush of claim 16, wherein the plurality of continuous openings in the T-shaped member are adjacent to a first end of the plurality of bristles.

19. The paint brush of claim 16, wherein the base of the brush head assembly is secured around the T-shaped member via the movable locking member.

20. The paint brush of claim 16, wherein the locking member is repositionable between a locked position and an unlocked position.
